(19) United States
(12) Patent Application Publication
(10) Pub. No.: US 2006/0147196 A1
(43) Pub. Date: Jul. 6, 2006

(54) Equipment crane, particularly camera crane

(76) Inventors: Dieter Hein, Windach (DE); Jordanis Melitopoulos, Grassau (DE)

Correspondence Address: DILWORTH & BARRESE, LLP, 333 EARLE OVINGTON BLVD., UNIONDALE, NY, 11553, US

(21) Appl. No.: 10/515,369

(22) PCT Filed: Mar. 7, 2003
(86) PCT No.: PCT/EP03/02369

§ 371 Date: Jan. 30, 2006

(30) Foreign Application Priority Data
May 22, 2002 (DE) 102226776

(51) Int. Cl. G03B 17/00

(52) U.S. Cl. 396/428

(57) ABSTRACT

The invention relates to a camera crane comprising a support (1) and a jib (2). A traction rope (9) of a control system is movable on a pivot bearing of the crane jib in order to establish a parallelogram system or displace said parallelogram system. The rope is also movable in the longitudinal direction thereof in order to be able to preadjust the angle at which camera-receiving plate is positioned.

### TECHNICAL FIELD

The invention relates to the field of lifting tackle and particularly to the field of crane technology in connection with the controlled guidance of equipments in three-dimensional spaces. The invention relates in particular to the guidance of a camera in a three-dimensional space by swiveling a crane jib with a camera attached to one of its ends.

### PRIOR ART

An equipment crane of this kind is known from DE 298 16 565 U1, DE 299 07 704 U1 and DE 299 16 225 U1. With the camera crane described there, the camera may be guided in a three-dimensional space by the swiveling motion of a crane jib, whereby parallelogram guidance enables the camera-receiving plate to be held in a specific alignment including also horizontal alignment during guidance through the three-dimensional space. However, it is also possible to change the rope guidance used in the parallelogram system so that there is no longer any parallelogram setting. The camera-receiving plate may be preadjusted in one direction or the other in relation to the setting angle.

### DESCRIPTION

The technical problem (object) of the invention is to create an equipment crane, particularly a camera crane, with which the guidance system may be installed and adjusted with simplified technical means and hence an equipment and/or camera guidance may be configured more variably.

This object is achieved by means of an equipment crane, particularly camera crane, with a crane support and a crane jib articulated pivotably thereto at a first articulation point, an equipment-receiving element articulated to a second articulation point at the end of the crane jib facing away from the crane support, to which is articulated at a third articulation point a traction element, particularly a traction rope, at a distance from the second articulation point between the crane jib and equipment-receiving element, which extends from the third articulation point on the equipment-receiving element to a fourth articulation point on the crane support, with said fourth articulation point being arranged at a distance to the first articulation point, whereby the fourth articulation point is arranged displaceably on the crane support, and whereby the traction element has an adjustable length. The traction element is hereby continued past the fourth articulation point and fixed to the crane support.

The provides in a simple way the possibility of manipulating the continued end of the traction element in order simultaneously to adjust the angle at which the equipment-receiving element is positioned, adapt the length of the traction element, if the crane jib is designed as a telescopic jib or as another type of length-adjustable crane jib, and effect the displacement of the fourth articulation point on the crane support, in order either to establish parallelogram guidance or guidance outside the parallelogram system.

Preferably, the traction element is fixed to a clamping point. However, the traction element may also be provided with an attached latching element, which may be latched in a detachable way in a mobile latching point on the crane support. It is possible in a simple way to adapt the length of the traction element to the length of a telescopic jib if several latching elements of this kind are attached to the traction element at longitudinal distances.

If, at the same time, the latching point can be displaced in the direction of travel of the traction element, this fixing of the traction element in the area of the crane support permits a simple adjustment of the setting angle of the equipment-receiving element via the traction element.

According to one advantageous embodiment and with regard to the simplest possible handling by the operator, the fourth articulation point may be arranged on one side of the crane support and the latching point may be arranged on the opposite side.

In another embodiment, the fourth articulation point may take the form of a preferably pivoted rope pulley around which the traction element runs at least partially and is guided from there to the latching point. This enables the fourth articulation point to be displaced with the necessary arranging space on one side of the crane support and the traction element to be shortened by the adjustment of the setting angle on the other side of the crane support.

For a preferred arrangement of the adjustment possibilities on both sides of the crane support, a deflection pulley for the traction element may be provided behind the rope pulley in the direction of the latching point, with its axis being arranged parallel to the axis of the rope pulley, and which is secured to the crane support, to which is connected at least one further deflection pulley with its axis arranged perpendicularly to the axis of the first deflection pulley so that the traction element running between them lies tangentially on the circumference of the two deflection pulleys.

To combine the parallelogram guidance with guidance for the traction element outside the parallelogram system, the preferred axis of the rope pulley is arranged on the first articulation point. The crane jib is pivotably mounted on this first articulation point.

### BRIEF DESCRIPTION OF THE DRAWINGS

The drawings are a purely schematic representation of an example of an embodiment. They show:

FIG. 1 a perspective view of a camera crane according to the invention

FIG. 2 a perspective view of the side of the crane support to which the traction rope is attached and

FIG. 3 a perspective view of the other side of the crane support to which the end of the traction rope is attached.

### DESCRIPTION OF AN EXAMPLE OF AN EMBODIMENT

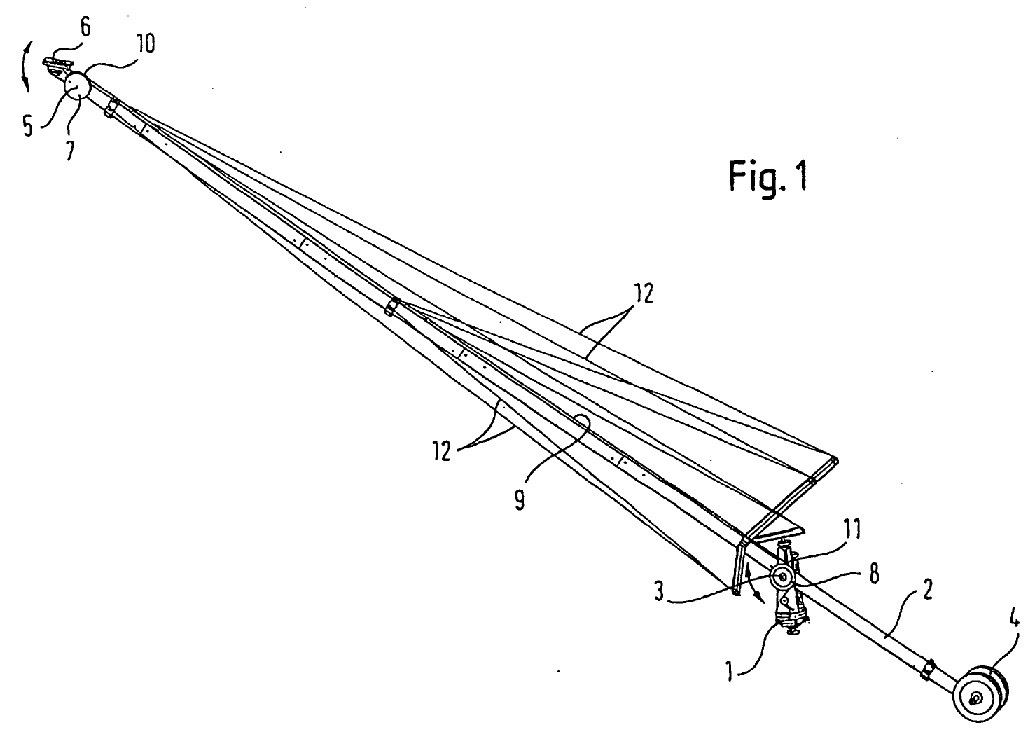

A camera crane shown in FIG. 1 comprises a crane support 1, only part of which is shown in FIG. 1. The lower part of the crane support 1 is not shown here, but may take the form of a tripod. In addition, the camera crane comprises a crane jib 2, which is pivotably mounted on a first articulation point 3 on the crane support 1. There is a counterweight 4 on the right-hand end of crane jib 2 in the drawing. A camera-receiving plate 6 designed as camera-holding element is pivotably mounted at the opposite end of the crane jib 2 at a second articulation point 5. In the embodiment shown here (to which the invention is not restricted), a rope pulley 7 is pivotably mounted together with the camera-receiving plate 6 with its centre in the area of the second articulation point 5. Without implying any restriction to this example of an embodiment, a similar rope pulley 8 is located at the first articulation point 3 so that its centre is arranged on this articulation point, which is simultaneously the swivel axis of the crane jib 2. Between these pulleys 7 and 8, a traction rope 9 runs in such way that a third articulation point 10 is formed on the tangential contact point of the traction rope 9 on the circumference of the rope pulleys 7 and 8 in the area of the camera-receiving plate 6 and a fourth articulation point 11 is formed in the area of the crane jib pivot mounting. If this traction rope 9, which is simultaneously a control rope, runs parallel to the crane jib 2, the crane jib together with the traction rope 9 and the articulation points 3, 5, 10, 11 form a parallelogram system in such a way that when the crane jib 2 is swiveled, the camera-receiving plate 6 may be held in either an exactly horizontally aligned position or in a specific inclined position if the camera-receiving plate 6 is moved in the three-dimensional space by means of the crane jib 2 when it is swiveled in the crane support 1.

The crane jib 2 may then have a relatively lightweight design if it is reinforced by rope struts 12. In addition, the length of the crane jib 2 can be altered if, for example, the crane jib is telescopic or if the crane jib 12 comprises several sections that are inserted into each other so that it may be shortened or lengthened. Here, the rope struts 12 are slung on as appropriate and the course of the traction rope 9 is also suitably adapted, that is shortened or lengthened.

If a telescopic jib is involved in the crane jib length adjustment, this expression also covers the aforementioned plug-in connection.

The rope pulleys 7 and 8 do not have to, but can be, pivoted, whereby the rope pulley 8 is preferably pivoted about its axis. The rope pulley 7 may normally be pivoted with the camera-receiving plate.

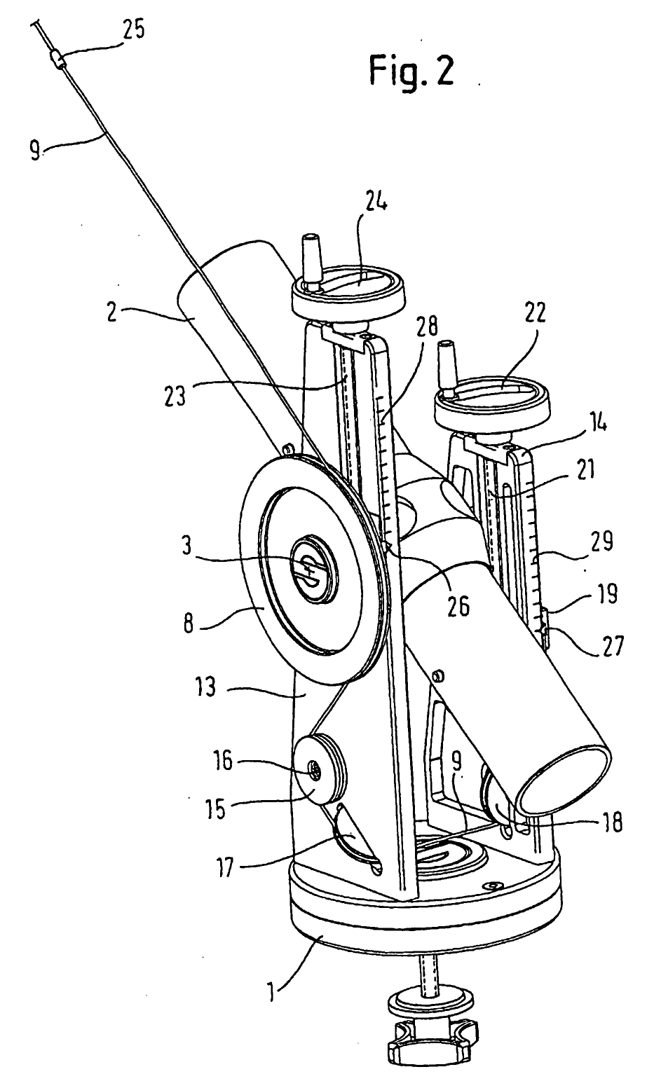

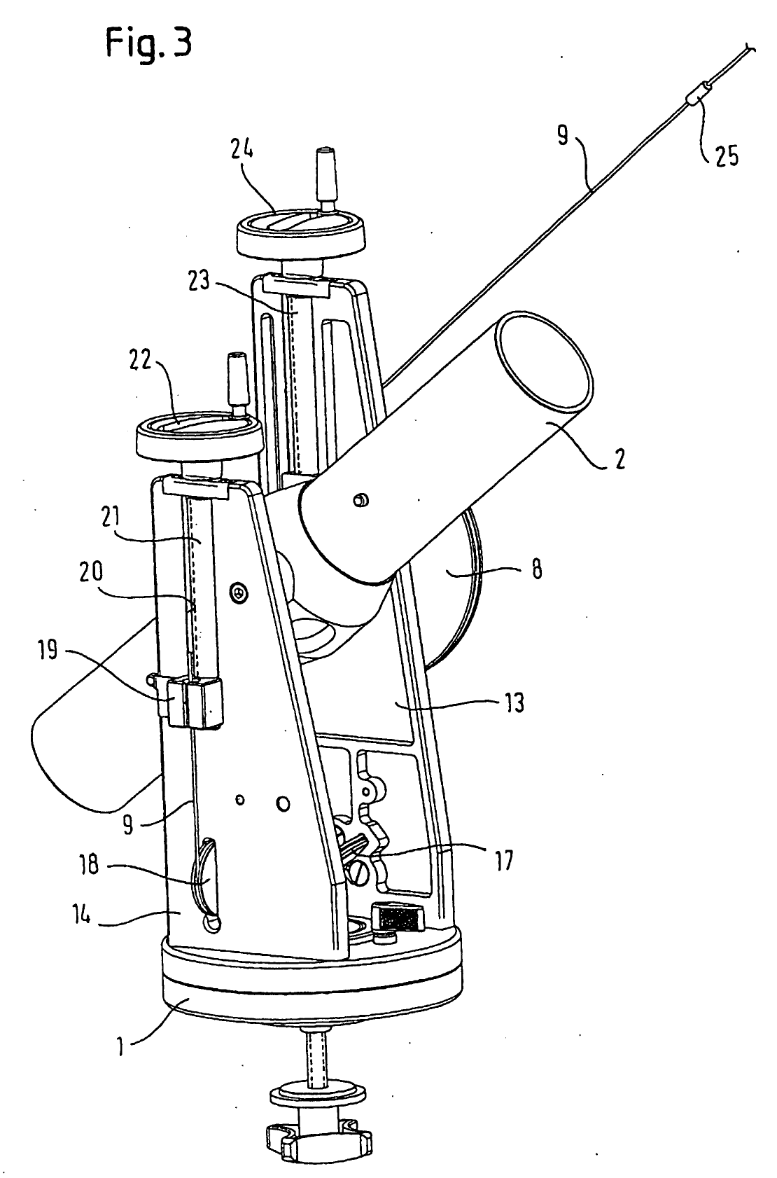

The crane support shown in isolation in FIG. 2 with no supporting structure only illustrates one part of the crane jib 2. However, FIG. 2 shows individual details more clearly than FIG. 1, particularly the rope pulley 8 with the first articulation point 3, which is located in the swivel axis of the crane jib 2 and which stays with the axis of the rope pulley 8 when the parallelogram system is adjusted. Also clearly identifiable is the traction rope 9, which emerges from the rope pulley 7, not shown, runs partially about the rope pulley 8 and continues, whereby the end of the rope is attached to the crane support 1. This may, in principle, be provided on the same side of the crane support. Here, the rope pulley 8 is located on one side of the crane support and the fixed end of the traction rope 9 is located at the other end of the crane support, whereby a major support 13 and a minor support 14 are provided. Although it is also possible to fix the rope end on the crane support 1 on the same side, that is on the side of major support 13, this drawing shows a split solution in which the traction rope 9 is guided partially around the rope pulley 8 and from there guided partially around a deflection pulley 15. The axis of rotation 16 of this deflection pulley 15 runs parallel to the axis of the rope pulley 8. From the deflection pulley 15, the traction rope 9 runs partially around a deflection pulley 17 whose axis rotates perpendicular to the axis 16 of the deflection pulley 15. From there, the traction rope 9 runs from the major support 13 to the minor support 14 and in this is again guided around another deflection pulley 18, which may also be seen in FIG. 3. From there, the traction rope 9 runs to a suspension element 19 forming a latching point. This suspension element 19 is mounted displaceably in a recess 20 in the minor support 14, and, to be precise, in the direction corresponding to the course of the traction rope 9 at this point. Here, this suspension element 19 takes the form of a spindle nut and sits on a spindle bolt 21. If this spindle bolt 21 is turned by means of a rotary lever 22, the position of the suspension element 19 relative to its position in the direction of the spindle bolt 21 may be changed. The consequence is that traction is applied to the traction rope 9 in the relevant direction. This in turn has the result that the angle of the camera-receiving plate 6 changes. This adjustment possibility may also be used to set the desired angle of the camera-receiving plate 6. If parallelogram guidance is set by means of the traction rope 9 and the crane jib 2, this position may then be maintained in the event of the crane jib being swiveled. However, it is possible to dispense with this parallelogram guidance. To do this, a similar spindle-nut system with a spindle bolt 23 and a lever 24 may be used to change the position of the rope pulley 8 in the major support 13 and indeed in approximately the same direction as the adjustment of the suspension element 19, which on the one hand permits the exact setting of the parallelogram system, but on the other hand an adjustment may be made in that the traction rope 9 leaves the parallelogram system to a greater or lesser extent. This adjustment results in a change to the angular position of the camera-receiving plate 6 and also in the desired setting of the change to the angle of the camera-receiving plate during the swiveling of the crane jib.

The suspension of the end of the traction rope 9 in the suspension element 19 is achieved by a receiving or latching element 25 fixed to the traction rope, which is not identifiable in the suspended condition but is implemented by a latching element 25 shown in the path of the traction rope 9, which takes effect when the crane jib 2 is shortened. Then, the traction rope 9 is pulled through the described deflection equipment and at the same time the latching element 25 is suspended so that there is a surplus of traction rope 9 that may be suspended at a suitable point on the crane support 2 so that this surplus is not an impediment.

The rope pulley 8 is provided with a pointer 26 and the suspension element 19 is provided with a pointer 27. These pointers 26, 27 interact with a scale 28 or 29 in such a way that it is easily possible to introduce a corresponding visible adjustment.

Decoupling the adjustment on two sides enables a clearer layout and a more effective setting.

1-9. (canceled)

10. Equipment crane, particularly camera crane, with a crane support (1) and a crane jib (2) articulated pivotably thereto at a first articulation point (3), an equipment-receiving element (6) articulated to a second articulation point (5) at the end of a crane jib facing away from the crane support (1) to which is articulated a traction element (9) at a distance to the second articulation point (5) between the crane jib (2) and the equipment-receiving element (6) on a third articulation point (10), said transaction element extending from the third articulation point (10) on the equipment-receiving element (6) to a fourth articulation point (11) at a distance to the first articulation point (3) on the crane support (1), whereby the fourth articulation point (11) is arranged adjustably on the crane support (1) and whereby the traction element (9) has an adjustable length, wherein the traction element (9) is continued beyond the fourth articulation point (11) and fixed directly to the crane support (1).

11. Equipment crane according to claim 10, wherein the traction element (9) is fixed to a clamping point.

12. Equipment crane according to claim 10, wherein the traction element (9) is provided with an attached latching element (25) which may be latched into a latching point (19) on the crane support in a detachable manner.

13. Equipment crane according to claim 10, wherein the crane jib (2) is telescopic and several latching elements (25) are attached to the traction element (9) at longitudinal distances.

14. Equipment crane according to claim 10, wherein the fourth articulation point (11) is arranged on one side of the crane support and the latching point (19) is arranged on the other side of said crane support.

15. Equipment crane according to claim 12, wherein the latching point (19) is adjustable in the direction of the course of the traction element (9).

16. Equipment crane according to claim 10, wherein the fourth articulation point (11) takes the form of a preferably pivoted rope pulley (8) around which the traction element (9) runs at least partially and is guided from there to the latching point (19).

17. Equipment crane according to claim 16, wherein a deflection pulley (15) for the traction element (9) is provided in the direction of the latching point (19) behind the rope pulley (8) with its axis (16) arranged parallel to the axis of the rope pulley (8) and which is secured to the crane support (1), on which is arranged at least one further deflection pulley (17) with an axis perpendicular to the axis (16) of the first deflection pulley (15) so that the traction element (9) running between them lies tangentially on the circumference of the two deflection pulleys (15, 17).

18. Equipment crane according to claim 16, wherein the axis of the rope pulley (8) is arranged on the first articulation point (3).
